(19) United States
(12) Patent Application Publication
(10) Pub. No.: US 2003/0103144 A1
(43) Pub. Date: Jun. 5, 2003

(54) Digital camera having image transfer method and system

(76) Inventors: Robert Sesek, Meridian, ID (US); Chad A. Stevens, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/000,029

(22) Filed: Dec. 4, 2001

(51) Int. Cl. H04N 5/225

(52) U.S. Cl. 348/207.1

(57) ABSTRACT

A digital camera is provided that has image transfer capabilities. When the transfer of an image is desired, a user selects an image transfer option via a user interface. A transfer logic allows a user to search and select one or more images from memory and select one or more destination addresses for each image. An RF transceiver circuit and antenna establish communication with a portable proximity device having a compatible RF transceiver. The images are transferred to the proximity device which in turn establishes communication with a network. The images are then transmitted to the network which distributes the images to their respective destination addresses, for example, to e-mail addresses. With the present invention, images or other data can be transmitted to a recipient from any location as long as a proximity device is available.

### FIELD OF THE INVENTION

The invention relates to the digital imaging arts. It finds particular application to a digital camera that has an image transfer method and system. It will be appreciated that the present invention will find application in other portable electronic devices that have data capable of being transmitted to a recipient.

### BACKGROUND OF THE INVENTION

People around the world enjoy photography and distributing photographic prints to their friends, relatives, and neighbors. Simplifying the picture-taking process is the new generation of digital cameras that form images in a simple operation using digital technology. Digital images are stored in an internal or removable storage device just as any type of computer data file thus allowing it to be identically reproducible and easily managed.

With prior art digital cameras, in order to give a friend an image, a user would connect the camera to a personal computer using a cable and download the image. Alternatively, the user would remove the removable storage device that contains stored images from the camera, and connect the removable storage device to the personal computer. The personal computer executes a program that can read the stored images, either from the camera or the removable storage device. Once on the computer, the user could then send the images to a printer, print them and deliver the hardcopy to the friend. Alternately, the images could be transmitted by e-mail or other file transfer method to the friend using the computer's Internet or other network communication capabilities.

One problem with this approach is that a user of the digital camera is required to use the personal computer to perform a transfer of images. Thus, transferring of images is not possible when the user does not have access to a computer. There is a need to simplify and expedite the process of sending pictures or other data from a device to a recipient when a physical connection to a computer is not available.

The present invention provides a new and useful method and system of transferring digital images that cures the above problems and others.

### SUMMARY OF THE INVENTION

In accordance with one embodiment of the present invention, a digital camera is provided. The camera includes memory for storing digital images. A wireless short range radio frequency transceiver communicates with a proximity device that has a compatible wireless short range radio frequency transceiver. A user interface allows a user to select a transfer mode and select one or more digital images from the memory to be transferred. The user interface further allows the user to select a destination address for the one or more digital images. A transfer logic that, in response to the transfer mode being selected, generates transfer instructions that cause the short range radio frequency transceiver to establish communication with a proximity device and to transfer the selected one or more digital images to the proximity device for further transfer to the destination address.

In accordance with another embodiment of the present invention, a method of transferring digital images is provided in a digital camera. An instruction is received, from a user, to transfer one or more selected digital images to one or more selected destination addresses. A radio frequency communication is established with a proximity device. The selected digital images and the selected destination addresses are then transmitted to the proximity device. Transfer instructions are also transmitted to the proximity device which cause it to establish wireless communication with a remote network and to transmit the selected digital images to the selected destination addresses via the remote network.

One advantage of the present invention is that it allows transferring of images from a digital camera to a destination address without having to first download the images to a computer.

Still further advantages of the present invention will become apparent to those of ordinary skill in the art upon reading and understanding the following detailed description of the preferred embodiments.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to demonstrate the principles of this invention.

FIG. 1 is an exemplary system diagram of a digital camera in accordance with an embodiment of the present invention;

FIG. 2 is an exemplary diagram showing communication links for transferring images in accordance with an embodiment of the present invention;

FIG. 3 is an exemplary methodology of transferring an image from a digital camera in accordance with an embodiment of the present invention.

### DETAILED DESCRIPTION OF ILLUSTRATED EMBODIMENT

The following includes definitions of exemplary terms used throughout the disclosure. Both singular and plural forms of all terms fall within each meaning:

“Address”, as used herein, includes but is not limited to one or more communications network accessible addresses, e-mail addresses, a distribution list including one or more e-mail addresses, url and ftp locations or the like, network drive locations, a postal address, a combination of an e-mail address and a postal address, or other types of addresses that can identify a desired destination.

“Signal”, as used herein, includes but is not limited to one or more electrical signals, analog or digital signals, one or more instructions, a bit or bit stream, or the like.

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other logic device. Logic may also be fully embodied as software.

The present system and method provides the capability of directly sending an image from a digital camera by e-mail or posting to a networked share location. As described in greater detail below, the digital camera includes a short range wireless communication system that communicates with a compatible communication system incorporated in a nearby transferring device such as a computer or cellular phone. A user selects one or more images stored on the digital camera and transmits them to the transferring device. The transferring device further receives instructions to connect to a network and deliver the images to one or more recipients identified by one or more selected addresses. For example, if the user is taking pictures while in the woods and the camera memory becomes full, the user can transmit images by radio frequency signals to a compatible cellular phone which in turn transmits them to the user's computer or other destination via a network connection. The transmitted images can then be deleted from the camera's memory thus freeing its memory capacity. Another use includes automatically sending pictures of an event to a friend or relative as the event occurs without having to download the pictures and then transmit them.

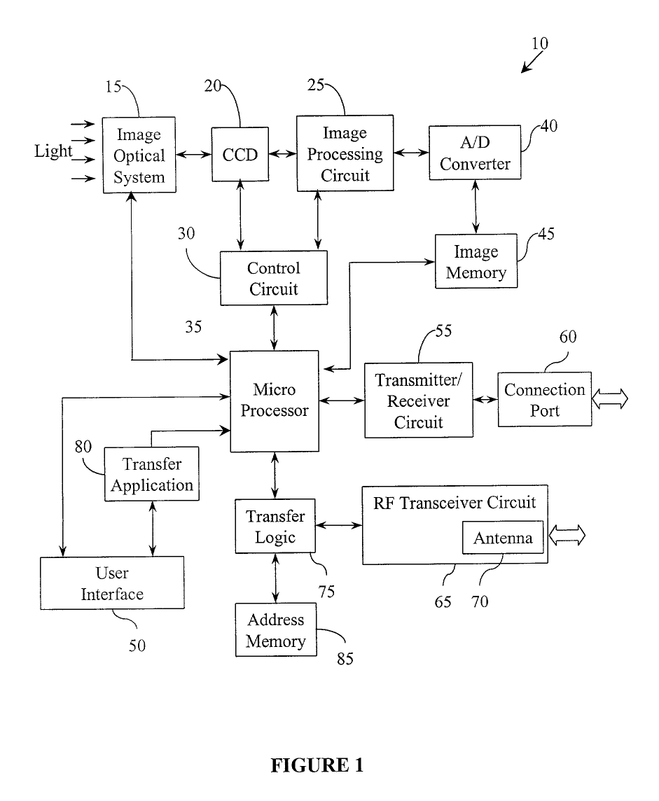

Illustrated in FIG. 1 is a simplified component diagram of an exemplary imaging device 10 such as a digital camera in accordance with the present invention. The camera components are contained in a portable housing (not shown) that may have any desired configuration. In a photographing mode, light is received by an imaging system in the camera that generates a digital image representative of the light. In particular, the light passes through an image optical system 15 that may include one or more lenses and light filters. The light is focused on a light sensitive device, such as charge-coupled device (CCD) 20 which photoelectrically converts the sensed light to electrical image signals. An analog image processing circuit 25 processes the image signals by performing color balancing and other image property adjustments as is known in the art.

A control circuit 30 synchronizes the operations of the CCD 20 and the processing circuit 25 according to instructions from a microprocessor 35. An analog-to-digital (A/D) converter 40 then converts the analog image signals from the image processing circuit 25 into digital image signals that form a digital image of the sensed light. The digital image is stored in an internal image memory 45 such as a frame memory, flash memory or may also include a removable storage device such as a memory card or the like. Each image is stored as a data file within the memory which may be searched and selected for subsequent processing such as being transferred to another device as will be described below.

A user controls the operation of the camera 10 through a user interface 50 which may include a display screen and one or more buttons to select options or control camera settings. The display screen can be touch sensitive as well. The user interface 50 executes a menu application showing various programmed options and functions that are available to the user. The microprocessor 35 detects the activation of buttons and selected options from the user interface 50 and initiates a corresponding action. If an activated button controls features such as zooming of images, the microprocessor 35 controls the operation of the image optical system 15 and drives, for example, a zoom motor (not shown) so as to move a zoom lens in the image optical system 15. The microprocessor 35 also controls an automatic focus system (not shown) which includes a driving circuit and a focus motor to perform distance measuring and image focusing. The microprocessor 35 further controls communication between the components of the camera as needed.

With further reference to FIG. 1, to transfer an image from image memory 45 to an external device, the camera 10 includes a transmitter/receiver circuit 55 and a physical connection port 60. The port 60 allows the camera to be connected to a computer or other device via a cable using any known communication protocol such as EIA-232 (formally known as RS-232). The EIA-232 (“Electronics Industry Association”) standard defines a computer's serial port, connector pin-outs, and electrical signaling.

However, a cable does not provide much assistance when there is no available computer for connection. This is the case, for example, when the user is traveling or is in a remote location such as hiking in the mountains. A situation may occur that the image memory 45 becomes full thus not allowing the user to store additional images. In another instance, the user may have taken a picture that they desire to immediately send to one or more locations.

To this end, the camera 10 includes a wireless RF transceiver circuit 65 with an antenna 70 that transmits and receives short range radio frequency signals. The transceiver 65 is controlled by a transfer logic 75 that coordinates image data to be transferred, destination addresses, and other transfer instructions to execute the data transfer. It will be appreciated that the transfer logic may be incorporated into the microprocessor 35 or as part of the RF transceiver circuit 65. To perform an image transfer, the user would select an image transfer option/mode through the user interface 50. A transfer application 80, upon receiving a request to transfer, is executed and includes a selection routine for allowing the user to search and select images from image memory 45, search and select destination addresses from an address memory 85 or from the memory of a connecting device (not shown), or other transfer options as described in more detail below. One implementation of the transfer application 80 may be a browser-like interface on the digital camera 10.

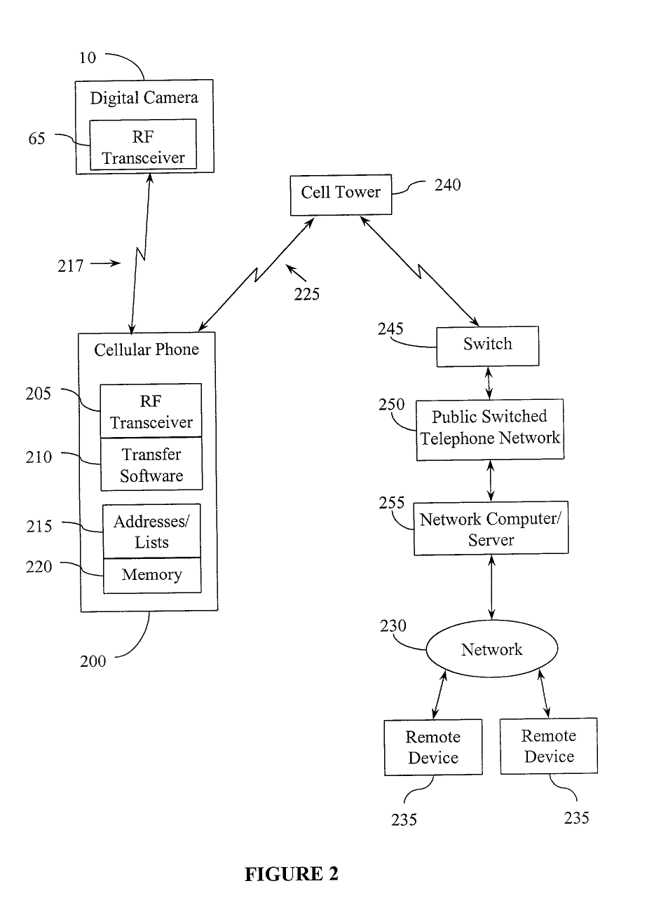

Illustrated in FIG. 2 is an exemplary communication diagram of the digital camera 10 transferring image data to a portable proximity electronic device 200 such as a cellular phone that has network connection capabilities. A proximity device as used herein includes a device that is within the communication distance range of the radio frequency signals of the camera's RF transceiver 65 and which will act as a transmission device for the camera. To establish radio frequency communication, the cellular phone 200 includes an RF transceiver 205 that is compatible with the RF transceiver 65 from the digital camera 10. The cellular phone further includes transfer software 210, described in greater detail below, that is responsive to the transfer instructions from the digital camera, and other known components such as addresses/distributions lists 215, memory 220, a processor and a wireless transmitter and receiver (not shown) as known in the art. Once radio frequency communication is established with the cellular phone 200 through wireless link 217, the digital camera 10 initiates the transfer of image data. Along with the image data, the transfer logic 75 includes instructions to the cellular phone that cause it to establish a wireless connection 225 ultimately communicating to a network 230. The image data is transferred via the network 230 to one or more remote devices 235 that correspond to the destination address(es) selected for the image data.

With further reference to FIG. 2, the operation of the cellular phone 200 is briefly described as follows. Essentially, cell phones use high-frequency radio signals to communicate with a cell tower(s) 240 located throughout a calling area. Currently, cell phones communicate in a frequency range of 806-890 MHz and 1850-1990 MHz for the newly allocated “PCS” frequency range. When the user wants to make a call, the cell phone 200 sends a message to the cell tower 240 requesting to be connected to a given telephone number. If the cell tower has sufficient resources to grant the request, a device called a switch 245 patches the cell phone's signal through to a channel on the public switched telephone network 250 (otherwise known as the PSTN). This call now takes up a wireless channel as well as a PSTN channel that will be held open until the call is completed. In the present case, the telephone number directs the connection to a network computer/server 255 that can establish a connection to the network 230. The network computer/server 225 may be an Internet Service Provider (ISP) that connects to the Internet, a server that connects to a local area network, or the like. With the connections established, image data from the camera 10 can be transmitted to a desired remote device 235.

As mentioned previously, the RF transceivers 65 and 205 communicate by short range radio frequency signals. A number of different industry standards for radio specifications exist. These radio specifications include, for example, the specification of Bluetooth Special Interest Group, referred to by the tradename Bluetooth, or the specification of the Institute of Electrical and Electronics Engineers Incorporated, referred to as IEEE 802.11. In addition to the industry standards for radio specifications, a number of design criteria mandated by various regulatory agencies, such as the Federal Communications Commission, also exist which may be taken into consideration when designing the RF transceivers.

In one embodiment, the RF transceiver 65 operates according to the Bluetooth specifications. This includes a Bluetooth PICO Net (BPN) antenna which couples the digital camera 10 and the cellular phone 200 through a through a wireless network. The BPN antenna is a circular polarization antenna which has a consistent transmission/reception sensitivity in every direction, with non-directional properties, or an antenna capable of radiating a plurality of polarized waves. The RF transceiver 65 may also be a radio, but could also be any other RF transceiver having a low power transmitter capable of short distance transmissions (e.g. less than 100 m). The RF transceiver 65 may be also be embodied as a microchip, or can be configured on a removable device such as a PCMCIA card (PC card) that is connectable to the digital camera 10 via a connection port or slot.

The Bluetooth Specification can be found at www.Bluetooth.com or other communications related Internet web sites. In general, a Bluetooth system provides a 1 Mb/sec data rate with low energy consumption for battery powered devices operating in the 2.4 GHz ISM (industrial, scientific, medical) band. The current Bluetooth system provides up to 100-meter range capability and an asymmetric data transfer rate of 721 kb/sec. The protocol supports a maximum of three voice channels for synchronous, CVSD-encoded transmission at 64 kb/sec. The Bluetooth protocol treats all radios as peer units identified by unique 48-bit addresses. At the start of any connection, the initiating unit is a temporary master. This temporary assignment, however, may change after initial communications are established. Each master may have active connections of up to seven slaves. Such a connection between a master and one or more slaves forms a “piconet.” Link management allows communication between piconets, thereby forming “scatternets.” Typical Bluetooth master devices include cordless phone base stations, local area network (LAN) access points, laptop computers, or bridges to other networks. Bluetooth slave devices may include cordless handsets, cell phones, headsets, personal digital assistants, digital cameras, or computer peripherals such as printers, scanners, fax machines and other devices.

The Bluetooth protocol uses time-division duplex (TDD) to support bi-directional communication. Frequency hopping spread-spectrum technology accommodating frequency diversity permits operation in noisy environments and permits multiple piconets to exist in close proximity. This is so since frequency diversity is inherent in frequency hopping, especially when it is wide, as in the case of Bluetooth (spread over a band of about 80 MHz). The frequency hopping transmission hops at a rate of 1600 hops per second over 791-MHz channels between 2402 MHz and 2480 MHz. Most countries currently operate in a band of about 2400 MHz to 2483.5 MHz. Various error-correcting schemes permit data packet protection by ⅓- and ⅔-rate forward error correction. Further, Bluetooth can use retransmission of packets for guaranteed reception.

Alternately, the RF transceiver 65 is configured to operate according to IEEE 802.11 protocol. Details of this communication protocol can be found on the Internet at www.ieee822.org. Of course, it will be appreciated by those skilled in the art that the above described frequency bands may change in the future. Thus, the present invention can be modifiable to meet future communication requirements and/or standards. An alternative embodiment includes using infrared communication as a method of data transfer between the camera 10 and transmission device 200.

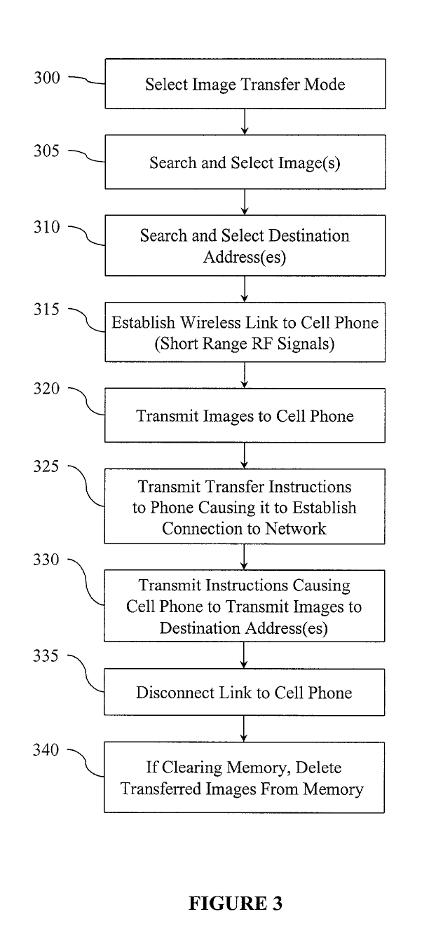

Illustrated in FIG. 3 is an exemplary methodology of the system shown in FIGS. 1 and 2 for transmitting images from the digital camera 10 to a destination address by way of an intermediate transmission device such as a cell phone. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object oriented or artificial intelligence techniques. It will further be appreciated that, if desired and appropriate, some or all of the software can be embodied as part of a device's operating system.

With reference to FIG. 3, at some point while operating the digital camera 10, the user will desire to transmit an image to a desired recipient. The user interface 50 includes a menu application and options from which the user selects to perform an image transfer (block 300) which activates the transfer application 80. The transfer application includes logic that allows the user to browse or search through the camera's image memory 45 to select one or more images that the user wishes to transmit (block 305). For each image selected, one or more destination addresses are selected corresponding to the desired recipient (block 310). In one embodiment, addresses may be stored within the address memory 85 in the camera, for example, which have been previously downloaded from another device or directly entered by a user. Another option may include allowing the user to browse addresses stored on a connecting device after communication is established. Yet another option can be to select addresses or a distribution list that resides on the network server 255 so that it performs much of the separate data transmissions to the multiple destinations rather than having the cellular phone perform the transmissions independently. This helps to reduce connection time for the phone.

For purposes of this explanation, the connecting device is a cellular phone that is located within the radio frequency distance range of a cell tower and includes a compatible radio frequency transceiver 205. The cellular phone is also configured to perform the described functions in accordance with the present invention. For example, the cellular phone includes appropriate software or logic that is responsive to the transfer instructions and other signals transmitted from the digital camera 10.

The camera 10 begins to initiate a wireless communication link by transmitting short range radio frequency signals, as described above, until a connection is established with the cellular phone 200 (block 315). If a connection is not made, additional attempts can be made as well as informing the user to try again later. It will be appreciated that establishing the communication link can be performed at various points within the exemplary process.

After the connection 217 is established and the images and destination addresses are selected, the images and addresses are transmitted to the cellular phone and stored in its memory (block 320). The transferred data can be buffered as necessary. The cellular phone, in accordance with the communication protocol, returns acknowledgment signals and error check messages to verify the accuracy of the data transmission. Along with the image data, the camera transmits transfer instructions that cause the cellular phone to perform the transfer of the image data to the selected destination address (block 325). In particular, the transfer instructions cause the cellular phone to establish a communication link with a network (e.g. Internet, local area network, intranet, etc.) that is associated with the destination address. If the destination address includes addresses from different networks, separate connections would be made to perform the image data transfer.

With further reference to FIG. 3, the transfer instructions generated and sent by the camera further include instructions that cause the cellular phone to transmit the selected images to the destination addresses after the communication link is established with the network 230 (block 330). These instructions may include timing instructions, selected by the user, that instruct the cellular phone when to transmit the selected images. For example, the images can be transmitted to the network while the camera is on-line with the cellular phone, or off-line at a later time and/or date. An off-line data transfer allows the user to continue operation of the camera without having to wait for the entire data transfer to be completed. The communication link between the camera and phone is then disconnected (block 335). In the case where the image transfer was performed to free-up memory in the camera, the transferred images can be deleted from the image memory 45 and the user may take and store more pictures as desired (block 340).

If desired, the transferred data can be compressed, for example, using lossy or lossless compression techniques as known in the art. This may be an option that the user selects or can be a pre-set default option. The transfer logic may maintain a list of default options so as to not burden the user to make selections for each image transfer. In one embodiment, the compression option simply sets a flag which is transmitted to the cellular phone as a transfer instruction. The cellular phone then performs the actual data compression in response to the instruction.

Additional options can be incorporated into the above system. For example, the transfer software 210 on the cell phone 200 can be programmed to allow the user to add text, such as a greeting or heading, to an image. This can also be programmed to allow the user to record a voice message that is transmitted along with an image.

Another application of the present invention includes transmitting images to a photo service which then sends hardcopy images to the selected recipient(s). For example, image data is transferred from the camera to a photo service account by email. The transferred data includes instructions indicating a destination address such as a postal address and name. Upon receipt of the image data, the photo service generates a hardcopy of the image data, charges the user's account, and mails the hardcopy images to the postal address.

In an alternative embodiment, the RF transceiver 65 is configured into a removable networking card, which is attached to the digital camera. This configuration may be suited for a business environment where the camera establishes communication directly to the network. This also allows for other devices to be swapped in or out of this communication port.

With the present invention, a user can directly transmit images from a digital camera from any location to a desired recipient without having to first download or otherwise process the image on a computer. Rather, a portable proximity device, such as a cell phone, is used to perform data transfer which is more convenient to carry than a computer. The present invention also allows the memory of a camera to be freed without losing stored images since they can be transferred to another location. Alternately, transferred images may be used as backup copies rather than deleting them from the camera memory.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, instead of a cellular phone, the proximity device can be a conventional telephone connected by cable to a network, a personal digital assistant including wireless network communication or other portable computer. The transfer system and method can be implemented on other devices such as an MP3 player to allow transferring of recorded files. It will be appreciated that the invention may be designed as part of an original device or may be installed as an after-market product. This also applies to the components of the proximity device. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A digital camera comprising:
a imaging system that detects light and generates a digital image representative of the detected light;
a memory that stores images generated by the imaging system;
a user interface for receiving instructions from a user, including a transfer instruction to transmit one or more selected digital images to a selected address;
a wireless radio frequency transceiver for establishing data communication with a cellular device having a compatible wireless radio frequency transceiver by transmitting and receiving radio frequency signals;
a transfer logic that, in response to the transfer instruction, causes the radio frequency transceiver to transmit one or more selected digital images to a cellular device and to transmit connection instructions that cause the cellular device to establish communication with a network and to transmit the one or more selected digital images to the selected address; and
a microprocessor for controlling the imaging system, the memory, the user interface, the radio frequency transceiver and the transfer logic, and for controlling data communications therebetween.

2. The digital camera as set forth in claim 1 wherein the transfer logic includes instructions for disconnecting communication with the cellular device when the images are transferred thereto.

3. The digital camera as set forth in claim 1 wherein the selected address includes a plurality of addresses.

4. The digital camera as set forth in claim 1 wherein the wireless radio frequency transceiver operates according to IEEE 802.11 communications protocol.

5. The digital camera as set forth in claim 1 wherein the wireless radio frequency transceiver is a bluetooth transceiver.

6. The digital camera as set forth in claim 1 wherein the radio frequency transceiver is formed on a removable communications card.

7. The digital camera as set forth in claim 1 wherein the imaging system includes a charge coupled device.

8. The digital camera as set forth in claim 1 further includes a removable memory card for storing digital images.

9. The digital camera as set forth in claim 1 wherein the selected address is one or more email addresses.

10. In a digital camera, a method of transferring a digital image comprising the steps of:
receiving, from a user, an instruction to transfer a selected digital image to a selected destination address;
establishing a radio frequency communication with a proximity device;
transmitting the selected digital image and the selected destination address to the proximity device; and
transmitting transfer instructions to the proximity device causing the proximity device to establish wireless communication with a remote network and to transmit the selected digital image to the selected destination address via the remote network.

11. The method as set forth in claim 10 further including transmitting the selected digital image to a plurality of selected addresses.

12. The method as set forth in claim 10 further including, after the radio frequency communication is established, allowing the user to access information stored on the proximity device including an address book and selecting one or more addresses from the address book.

13. The method as set forth in claim 10 wherein the digital image is stored in a memory in the digital camera, the method further including deleting the digital image from the memory of the digital camera after the digital image is transmitted to the proximity device.

14. The method as set forth in claim 10 further including allowing the user to select one or more destination addresses from addresses stored on the proximity device.

15. The method as set forth in claim 10 further including providing a user interface allowing the user to select one or more digital images to be transferred and allowing the user to select one or more addresses to which the one or more digital images are to be transferred.

16. The method as set forth in claim 10 further including transmitting offline instructions to the proximity device causing the proximity device to transmit the selected digital image to the remote network after the radio frequency communication between the digital camera and the proximity device is disconnected.

17. A digital camera comprising:
a memory for storing digital images;
a wireless short range radio frequency transceiver for communicating with a proximity device having a compatible wireless short range radio frequency transceiver;
a user interface allowing a user to select a transfer mode and select one or more digital images from the memory to be transferred, the user interface further allowing the user to select a destination address for the one or more digital images; and
a transfer logic that, in response to the transfer mode being selected, generates transfer instructions causing the short range radio frequency transceiver to establish communication with a proximity device for transferring the selected one or more digital images to the proximity device for further transfer to the destination address.

18. The digital camera as set forth in claim 17 wherein the transfer instructions further include instructions transmitted to the proximity device causing the proximity device to establish a wireless network connection to a remote network and to transmit the one or more selected digital images to the destination address accessible by the remote network.

19. The digital camera as set forth in claim 18 wherein the proximity device is a cellular phone having a compatible wireless short range radio frequency transceiver configured to communicate with the digital camera, the cellular phone being capable of establishing the wireless network connection.

20. The digital camera as set forth in claim 17 wherein the wireless short range radio frequency transceiver is configured to operate according to one of IEEE 802.11 protocol and bluetooth protocol.

21. A system for transferring one or more data files from an electronic device to one or more destination addresses, the system comprising:
a transfer application for receiving one or more requests to transfer one or more data files;
a selection routine that, in response to a request to transfer, reads data from the electronic device and allows selection of one or more data files for transfer and allows selection of one or more destination addresses to be associated to the one or more data files; and
a transfer logic for causing the electronic device to transfer the one or more data files to a proximity device via radio frequency communications, the transfer logic including logic for instructing the proximity device to transfer the one or more data files to the one or more destination addresses.

22. The system as set forth in claim 21 wherein the electronic device is a digital camera.

23. The system as set forth in claim 21 wherein the electronic device is a personal data assistant.

24. The system as set forth in claim 21 wherein the proximity device is a telephone connected to a network via a cable.

25. The system as set forth in claim 21 wherein the proximity device is a cellular device.

26. The system as set forth in claim 21 wherein the transfer logic is formed as software, hardware, or a combination of both.

27. The system as set forth in claim 21 wherein the one or more destination addresses include addresses accessible over a network.

28. The system as set forth in claim 21 further including a radio frequency transceiver for communicating with the proximity device.
